(19) United States
(12) Patent Application Publication
(10) Pub. No.: US 2024/0273908 A1
(43) Pub. Date: Aug. 15, 2024

(54) VIDEO MONITORING DEVICE, AND METHOD, COMPUTER PROGRAM AND STORAGE MEDIUM FOR RETRAINING A VIDEO MONITORING DEVICE

(71) Applicant: Robert Bosch GmbH, Stuttgart (DE)

(72) Inventors: Dieter Joecker, Burgthann (DE); Florian Richter, Lamspringe (DE); Michael Meyer, Sibbesse (DE); Wolfgang Niehsen, Bad Salzdetfurth (DE)

(21) Appl. No.: 18/580,671

(22) PCT Filed: Jun. 27, 2022
(86) PCT No.: PCT/EP2022/067568

§ 371 Date: Jan. 19, 2024

(30) Foreign Application Priority Data
Jul. 22, 2021 (DE) 10 2021 207 849.4

(51) Int. Cl. G06V 20/52; G06V 10/764; G06V 10/82

(52) U.S. Cl. CPC G06V 20/52; G06V 10/764; G06V 10/82; G06V 2201/07

(57) ABSTRACT

A method for retraining a video monitoring device 1, wherein the video monitoring device 1 is provided with monitoring data 2, wherein the monitoring data 2 comprise images of a monitored region, wherein the monitoring data 2 are processed and/or analysed on at least two processing paths 5a,b, wherein the processing and/or analysis of the monitoring data 2 on the processing paths 5a,b each deliver a path result and an associated reliability measure, wherein at least one of the processing paths 5a,b forms an AI processing path, wherein the AI processing path is based on a neural network and is designed for object detection and/or object classification, wherein a difference between the reliability of the path result of the AI processing path and the reliability of the associated path results of the further processing paths 5a,b and/or a difference between the path result of the AI processing path and the path results of the further processing paths 5a,b is determined, wherein, if a threshold difference is exceeded by the determined difference then the associated path result of the AI processing path is set as the training object for retraining the neural network.

### BACKGROUND

The invention relates to a method for retraining a video monitoring device, wherein the video monitoring device is provided with monitoring data, wherein the monitoring data comprise images of a monitored region.

Video monitoring devices are used in public areas, for example for monitoring airports or train stations, as well as in private or commercial areas, for example for monitoring a company building or parking lot. For this purpose, cameras are used to record images that can be evaluated manually by a person, for example in a security control center, or evaluated with computer assistance by means of image processing methods. For example, objects in the images are detected and classified.

For example, publication DE 10 2007 041 893 A1 describes a method for detecting and/or tracking moving objects in a monitoring scene in which interfering objects can occur adjacent to the moving objects. The method provides for partitioning the monitoring scene into different regions with region classes, wherein the different region classes are monitored and/or evaluated with a different sensitivity.

### SUMMARY

A method for retraining a video monitoring device according to the disclosure is proposed. Further, a computer program, a machine-readable storage medium and a video monitoring device are proposed. Preferred and/or advantageous embodiments of the invention will emerge from the subclaims, the description and the accompanying figures.

A method for retraining a video monitoring device is proposed. The method can in particular be computer-implemented. The video monitoring device is, for example, a central monitoring device, for example, a security control center. The video monitoring device can in particular be designed as a computer module. The video monitoring device is in particular pre-trained, for example by a manufacturer. Pre-trained means, for example, that the video monitoring device is trained and/or has a basic reliability. The retraining is in particular used to improve the accuracy and/or reliability of the video monitoring device for detecting and/or classifying objects. The retraining is carried out in particular during operation and/or application of the video monitoring device. The method and/or the retraining is carried out in particular in an on-site application and/or an application with the user or customer. The retraining is carried out, in particular, using the video monitoring device within the application-specific environment and/or scene.

The video monitoring device is or will be provided with monitoring data. In particular, the video monitoring device may be designed to record the monitoring data, for example by comprising cameras and/or sensors. In particular, the monitoring data are provided from different sources, for example different cameras, sensors or data sources. The monitoring data include images of a monitored region. In particular, the monitoring data comprise different images of a common monitored region. For example, a section, in particular with overlap, of the monitored region is recorded by different cameras. Specifically, the monitoring data comprise videos, wherein the videos comprise images, for example, in particular as an image stream. The images and/or videos show the sections of the monitored region preferably from different viewing directions. Specifically, the images of the monitoring data overlap at least in pairs.

The method provides for processing and/or analysing the monitoring data on at least two processing paths. In particular, the processing and/or analysis on the at least two processing paths occurs independently. For example, the processing paths are formed by different analysis modules, for example software or hardware modules. The processing paths analyse and/or process the monitoring data in particular in different ways, for example using, detecting and/or classifying different characteristics or using different databases, for example different portions of the monitoring data. For example, a processing path is designed to evaluate the images, wherein another processing path is designed to evaluate the audio data. In particular, two processing paths may be provided for the analysis of the images, for example, wherein one of the processing paths performs an evaluation and/or analysis based on the optical flow field, wherein the other processing path applies an analysis and/or evaluation based on a pattern detection.

By processing and/or analysing the monitoring data, a path result and a reliability associated with the path result is obtained for each processing path. In particular, a processing path may deliver a plurality of path results, wherein a reliability is preferably obtained for each of the several path results. For example, the path result may describe and/or comprise a detected object, a detection object, or a classification of the object. For example, the associated reliability describes how reliable, accurate, and/or certain the path result is, for example, as a percentage of the reliability of correct detection. For example, the reliability indicates how certain or uncertain the path result is.

At least one of the processing paths forms or comprises an AI processing path. For example, an artificial intelligence processing path is understood as an AI processing path, i.e., an artificial intelligence processing path (AI processing path). The AI processing path is based and/or applies a neural network, in particular a convolutional neural network. The neural network is designed to detect objects and/or classify objects. In particular, the neural network is pre-trained and/or has basic reliability. The neural network is designed to detect and/or classify objects in the monitoring data, specifically the images. For example, the path result of the AI processing path comprises the detected objects and/or classified objects, wherein the associated reliability indicates a measure of trustworthiness, certainty, and/or reliability that the object has been correctly detected or classified.

A difference is determined. For example, the difference is determined as the difference between the reliability of the path result or one of the path results of the AI processing path and the reliability of a path result associated with the path result of at least one, in particular all, further processing paths. In other words, it is determined, for example, how much the reliability of a path result of the AI processing path differs from the reliability of the other processing paths for the respective object. Alternatively, and/or additionally, a difference is determined as a difference between the path result of the AI processing path and the path result or path results of the further processing paths. For example, it is determined whether an AI processing path result, for example, detected or classified object, has also been detected and/or classified in the other processing paths. The difference can in particular be determined in absolute or relative terms.

If the difference determined in this way exceeds a threshold difference, the associated path result of the AI processing path, in particular the detected or classified object, and/or the monitoring data on which the associated path result is based is set as a training object. The setting as a training object comprises in particular the associated image, for example the setting of the image as a training image. The training object is provided and/or used to retrain the neural network. The threshold difference is in particular a configurable threshold difference, specifically the threshold watt difference is an object or class-specific difference. By using the method, it is thus possible to find and/or obtain training objects for retraining the neural network that are specific to the application, scene or problem. In particular, training objects, which still lead to inaccurate or unreliable results for AI processing or the neural network, can thus be specifically obtained.

The method thus provides a method for improving the accuracy, reliability, and results of a video monitoring device that allows for classification and detection of objects in a variety of situations. Traditional methods of image processing which classify detected objects based on their characteristic such as size, shape and speed often provide insufficient accuracy, for example, when multiple objects overlap in the image or in difficult lighting conditions. Even known artificial intelligence methods or neural networks do not always have satisfactory reliability. Although these generally deliver better results, it is necessary that the objects to be detected are included in the correct views in the training material. Thus, a very large data set and a very large neural network with large memory and processing power requirements would be necessary for training. This is particularly based on the fact that the training objects actually required are very rare in the training material and the data required is subject to a long tail distribution. The present method makes it possible to specifically generate and obtain such training objects when using the video monitoring device during operation, such that the pre-trained video monitoring device specifically increases in accuracy over time due to the training objects thus obtained.

The video monitoring device is provided for routine use or operation on site, for example with the customer. The pre-trained video monitoring device is used in routine use with the customer in an application environment, for example, wherein the application environment is a company building, parking lot, airport, or train station. The method is used, applied or carried out in particular during routine use, in particular with the customer and/or the user. In particular, the monitoring data is processed and/or analysed on the various processing paths during routine use. Furthermore, it is particularly preferable that the determination of the difference and/or the setting as a training object is performed during application with the user or user, in particular in routine use. For example, the monitoring data is provided for use of the method by and/or in routine use. The monitoring data, in particular monitored images, preferably show and/or thus describe the application environment.

It is optionally provided that an overall reliability is determined based on the reliability of the processing paths, in particular the further processing paths. In particular, the further processing paths are understood as the processing paths without the AI processing path. The overall reliability may form an averaged and/or statistically evaluated reliability. For example, the reliability of the further processing paths may be weighted in the overall reliability. The difference between the reliability of the AI processing path and the overall reliability is defined here as the difference of the reliability. This embodiment is based on the consideration of determining underlying separation objects based on the difference between the reliability of the AI processing path and an overall reliability or leased reliability of the other processing paths, so that a statistical certainty is obtained.

One embodiment of the invention provides that the path result of the AI processing path is set as a training object if the reliability associated with the path result of the AI processing path is below a minimum reliability. For example, the reliability of the AI processing path does not differ from the overall reliability or the reliability of the further processing paths by more than the threshold value difference, so that the path result would not be set as a training object based on this criterion, but the reliability of the path result of the AI processing path is too low or less than the minimum reliability, such that such an object is provided as a training object or requires further investigation.

In particular, it is conceivable that the training object is added to a training data set. In particular, the training data set serves to retrain the neural network and/or the AI processing path. For example, training objects are collected in the training data set, wherein, based on the collection of the training objects in the training data set, the neural network is retrained at a given time or cyclically. For example, the training data set comprises detected objects and/or classified objects as training objects. In particular, the training data set comprises the monitoring data and/or images. For example, the training object to be added to the training data set is the associated image of the monitoring data. In particular, the training data set forms a collection of the images of the monitoring data that show or comprise the training objects.

In particular, the training object, specifically the image(s) of the monitoring data that the training object comprises, shows or delivers, is added as a positive or negative example to the training data set. In particular, the path result and/or reliability are added to the training data set.

It is particularly preferable to search for training data based on or for a training object in training databases. For example, the training databases are public databases of image material for training image processing or neural networks. In the training databases, for example, a search is made for training objects and/or images that are similar to that of the training object. The training data found in this manner is added to the training database. This configuration is based on the consideration that similar objects can be searched in existing databases so that further training material can be quickly obtained and the video monitoring device can be further improved.

Optionally, it is provided that artificial training data is generated based on the training object and/or the training objects. For example, artificial training data is understood to be the generation of one or more images based on the training object, for example the detected, classified object or associated image, and comprising the object in a similar but modified manner. For example, the object is adapted to a different background and/or scene or the view is changed. Specifically, the artificial training data is generated based on the training object, for example the associated image and a GAN (Generative Adversial Network). The artificial training data found is added to the training database. Specifically, generating the artificial training data can occur and/or follow using a further neural network to generate images.

Specifically, it is provided that the addition of the training object(s) and/or the training data to the training data set, in particular the training, occurs automatically. Alternatively, it is provided that the addition of the training object and/or the training data to the training data set is controlled, verified, and/or will be and/or is released by a person. For example, this may prevent unusable images from being added to the training data set. Specifically, the person may perform, control, or adjust a classification or detection of the objects, in particular training objects.

The object detection and/or object classification is carried out in particular based on an image evaluation of the monitoring data, in particular the images of the monitoring data. For example, detection or classification is based on object characteristics, for example size, shape, optical flow or speed.

Optionally, it is provided that the monitoring data comprises sensor data of at least one sensor, wherein the at least one sensor forms, for example, a radar sensor, an infrared sensor, for example a thermal imager, a lider sensor, a UV sensor, a distance sensor, or other sensors for detecting a physical, chemical, or mechanical quantity.

A further object of the invention is a computer program, in particular with program code means. The computer program is designed to run on a computer and/or the video monitoring device. The computer program is designed and/or configured to, when executed, apply, implement, perform, and/or assist the method for retraining the video monitoring device.

A further object is a machine-readable storage medium, wherein the computer program and/or the program code means of the computer program are stored on the storage medium.

A further object of the invention is a monitoring device with an analysis module. The analysis module comprises at least two processing paths. The video monitoring device is provided with monitoring data, wherein the monitoring data comprises images of a monitored region. In particular, the video monitoring device is designed and/or configured to perform the method for retraining the monitored video monitoring device as described above. The analysis module is designed to evaluate, process, and/or analyse the monitoring data using the at least two processing paths, which results in a path result and an associated reliability, respectively. In particular, multiple path results and/or multiple reliabilities may be obtained for a processing path. One of the processing paths forms an AI processing path, wherein the AI processing path is based on, comprises, and/or applies a neural network. The AI processing path is designed to detect and/or classify objects. The analysis module is designed to detect and/or classify objects by processing and/or analysing the monitoring data, in particular the images, using the AI processing path. The analysis module is designed to determine a difference, wherein the difference describes a difference between the reliability of the path result of the AI processing path and the reliability of the associated path result(s) of the further processing paths. Alternatively, the difference describes a difference between the path result of the AI processing path and the path result(s) of the further processing paths. The analysis module is designed to check whether the difference exceeds a threshold difference, wherein the analysis module is designed to apply and/or provide the associated path result, for example the object detection or object classification, in particular the image for retraining the neural network, in particular the AI processing path, if the threshold value difference is exceeded, for example to add a training data set.

### BRIEF DESCRIPTION OF THE DRAWINGS

Further advantages, effects and embodiments of the invention will emerge from the accompanying figures and their description. Shown are:

FIG. 1 a first exemplary embodiment of a monitoring device;

FIG. 2 a curve of the reliability over time;

FIG. 3 another exemplary embodiment of a video monitoring device.

### DETAILED DESCRIPTION

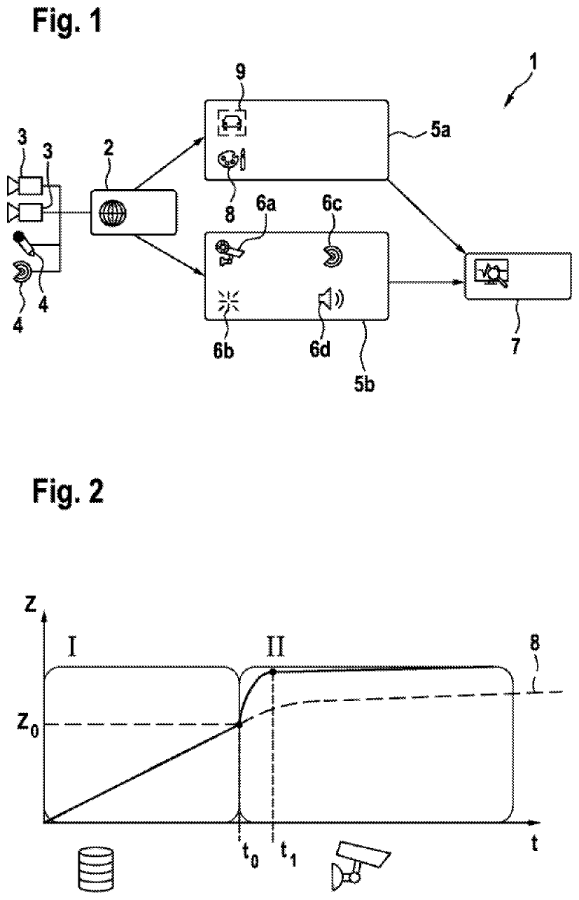

FIG. 1 shows a first embodiment of a video monitoring device 1. The video monitoring device 1 is provided with monitoring data 2. The monitoring data 2 are provided by cameras 3 and sensors 4, for example, a microphone or radar sensor. More specifically, the video monitoring device 1 comprises the cameras 3 and sensors 4. The monitoring data 2 in particular comprises images provided by the cameras 3, wherein the images are part of a video or image stream. The video monitoring device 1 comprises an analysis module, wherein the analysis module comprises at least two processing paths 5a,b, wherein the processing path 5a is designed as an AI processing path. The processing path 5b here comprises a plurality of processing paths for purposes of clarity, or can be divided into a plurality of processing paths, for example a processing path for traditional image evaluation 6a, a processing path for optical flow analysis 6b, one in the processing path for radar analysis 6c, and a processing path for audio analysis 6d. The processing path 5b or the partial processing paths 6 are designed to evaluate and/or analyse the monitoring data 2. For example, features or signal profiles are searched for in the monitoring data 2. In particular, the analysis and/or evaluation may comprise and/or form a statistical, physical, technical signal or mathematical evaluation. Path results are obtained from the processing paths 5b, which are provided together with an associated reliability of a difference determination module 7.

The processing path 5a, which is designed as an AI processing path, analyses and/or evaluates the images of the monitoring data 2. The AI processing path is designed to segment the images by the evaluation and/or analysis of the images, detect objects, and in particular classify them. The results of this analysis and/or evaluation are provided to the difference determination module 7 as a path result with an associated reliability measure. The difference determination module 7 is designed to determine a difference between associated path results of the different processing paths 5a,b, in particular the results of the AI processing path 5a and the further and/or further processing path 5b. If this difference exceeds a threshold difference, the associated image of the monitoring data 2 or the path result and/or associated reliability is used and/or set as a training object for retraining the AI processing path 5a.

FIG. 2 shows the curve of the reliability Z of the video monitoring device, in particular the AI processing path or the neural network over time t, by way of an example. The time is divided into two segments, a first segment I and a second segment II. The first segment I is a time interval required for training to achieve the basic reliability Z0. The is achieved at time t0. From the time t₀, the video monitoring device 1 is operated by the customer and/or the user so that scene-specific monitoring data and/or images are evaluated and/or analysed. Using the proposed method, specific training objects are obtained from the original data and/or artificially generated in modified form or searched for in databases, such that the neural network can be purposefully and efficiently retrained, such that a significant increase in reliability Z is already achieved at the time t₁. The traditional applications of neural networks only achieve this Will reliability with t towards infinity, wherein the curve of reliability Z for a traditional neural network is shown in graph 8.

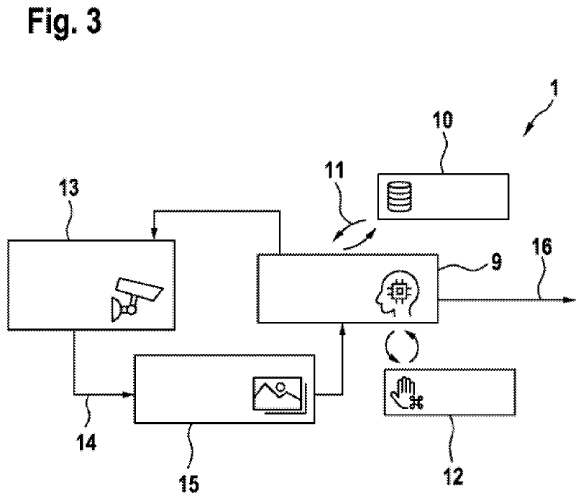

FIG. 3 shows a further exemplary embodiment of a video monitoring device 1 for clarifying the retraining. Here, the video monitoring device 1 generated a training data set 9 comprising a plurality of training objects obtained from the proposed method. The training objects, in particular from the training database 9, are used to search for similar objects, scenes or images in a training database 10. These images are added as training data 11 to the training data set 9. In particular, it may be provided that the training data set 9 or the training data and/or images contained therein are controlled and/or released by a user interaction 12.

The data of the training data set 9, in particular the images, training objects, path results and/or reliability contained therein, are evaluated by intelligent video and/or image analysis 13, for example by 3D model-based object verification, object tracking or flow determination. In particular, scene information may be used for analysis. A background model calibration 14 can be performed on and/or through this, which can be used to generate 15 artificial training data, such that artificial images are generated based on the training object, for example, by scene synthesis, domain adaptation and/or scene simulation. The artificial training data created and/or generated in this way is added to the training data set 9. The training data set 9 is in particular designed for the AI processing path 55.

1. A method for retraining a video monitoring device (1),
wherein the video monitoring device (1) is provided with monitoring data (2), wherein the monitoring data (2) comprises images of a monitored region,
wherein the monitoring data (2) are processed and/or analysed on at least two processing paths (5a,b), wherein the processing and/or analysis of the monitoring data (2) on the processing paths (5a,b) each deliver a path result and an associated reliability,
wherein at least one of the processing paths (5a,b) forms an AI processing path, wherein the AI processing path is based on a neural network and is designed to detect object and/or object classification,
wherein a difference between the reliability of the path result of the AI processing path and the reliability of the associated path results of the further processing paths (5a,b) and/or a difference between the path result of the AI processing path and the path results of the further processing paths (5a,b) is determined,
wherein, if a threshold difference is exceeded by the determined difference then the associated path result of the AI processing path is set as a training object for retraining the neural network.

2. The method according to claim 1, wherein the video monitoring device (1) is designed and/or provided for routine use in an application environment, wherein processing and/or analysing on the processing paths (5a,b), determining the difference, and/or setting as a training object occurs during routine use.

3. The method according to claim 1, wherein an overall reliability is determined based on the reliabilities of the further processing paths (5a,b), wherein the difference of the reliability of the AI processing path is determined based on the overall reliability.

4. The method according to claim 1, wherein the path result of the AI processing path is set as a training object if the associated reliability is below a minimum reliability.

5. The method according to claim 1, wherein the training object and/or associated image is added to a training data set (9), wherein the neural network of the AI processing path is retrained based on the training data set (9).

6. The method according to claim 5, wherein the training object is added to the training data set (9) as a positive or negative example.

7. The method according to claim 5, wherein, training data (11) is searched for in training databases (10) based on the training object, wherein the training data (11) comprises at least one image comprising an object similar to the training object, wherein the training data (11) found is added to the training data set (9).

8. The method according to claim 5, wherein, artificial training data (11) is created based on the training object, wherein the artificial training data (11) comprises at least one image comprising an object similar to the training object, wherein the training data (11) found is added to the training data set (9).

9. The method according to claim 5, wherein the addition of the training object and/or the training data (11) to the training data set (9) is controlled, verified and/or released by a person.

10. The method according to claim 1, wherein the object detection and/or object classification is based on an image evaluation of the monitoring data (2).

11. The method according to claim 1, wherein the monitoring data (2) comprises sensor data of at least one sensor (4), wherein the sensor (4) forms a radar, infrared, lidar, UV, speed and/or distance sensor.

12. (canceled)

13. A non-transitory, computer-readable storage medium containing instructions that when executed by a computer cause the computer to retrain a video monitoring device (1),
wherein the video monitoring device (1) is provided with monitoring data (2), wherein the monitoring data (2) comprises images of a monitored region,
by processing and/or analysing the monitoring data (2) on at least two processing paths (5a,b), wherein the processing and/or analysis of the monitoring data (2) on the processing paths (5a,b) each deliver a path result and an associated reliability,
wherein at least one of the processing paths (5a,b) forms an AI processing path, wherein the AI processing path is based on a neural network and is designed to detect object and/or object classification, and
by determining a difference between the reliability of the path result of the AI processing path and the reliability of the associated path results of the further processing paths (5a,b) and/or a difference between the path result of the AI processing path and the path results of the further processing paths (5a,b),
wherein, if a threshold difference is exceeded by the determined difference then the associated path result of the AI processing path is set as a training object for retraining the neural network.

14. A video monitoring device (1) , wherein the video monitoring device (1) is provided with monitoring data (2), wherein the monitoring data (2) comprise images of a monitored region, with an analysis module, wherein the analysis module comprises and forms at least two processing paths (5a, b) to process and/or analyse the monitoring data (2) on at least two processing paths (5a,b), wherein the processing and/or analysis of the monitoring data (2) on the processing paths (5a,b) each deliver a path result and an associated reliability measure, wherein at least one of the processing paths (5a,b) forms an AI processing path, wherein the AI processing path is based on a neural network and is designed for object detection and/or object classification, wherein the analysis module is configured to determine a difference between the reliability of the path result of the AI processing path and the reliability of the associated path results of the further processing paths (5a,b) and/or a difference between the path result of the AI processing path and the path results of the further processing paths (5a,b), wherein the analysis module is configured, if a threshold difference is exceeded by the determined difference to set the associated path result of the AI processing path as the training object for retraining the neural network.
